(19) United States
(12) Patent Application Publication
(10) Pub. No.: US 2024/0383449 A1
(43) Pub. Date: Nov. 21, 2024

(54) HOT AIR BLOWER FOR ICE AND SNOW REMOVAL

(71) Applicant: Mark Stockstill, SR., Chicago, IL (US)

(72) Inventor: Mark Stockstill, SR., Chicago, IL (US)

(21) Appl. No.: 18/199,778

(22) Filed: May 19, 2023

(51) Int. Cl. B60S 3/04; F04D 25/06; F04D 27/00; F04D 29/58

(52) U.S. Cl. CPC B60S 3/044; F04D 25/0673; F04D 27/004; F04D 29/582

(57) ABSTRACT

An ice and snow removal apparatus for removing ice and snow from automobiles and other objects includes a housing and an extendable duct attached to the housing. A blower is mounted in the housing for blowing air through the duct. A heater is mounted in the housing for heating the air.

### CROSS-REFERENCE TO RELATED APPLICATIONS

Not applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to ice and snow removal apparatus and more particularly pertains to a new ice and snow removal apparatus for removing ice and snow from automobiles and other objects.

### (2) Description of Related Art Including Information Disclosed Under 37 CFR 1.97 and 1.98

The prior art discloses several handheld apparatuses for clearing ice and snow from automobiles and other objects. Some such apparatuses include a housing with a blower and a heater to blow hot air onto the ice and snow, thereby melting and blowing the ice and snow away. However, the prior art fails to describe such an apparatus that uses an extendable duct to adjust where the heated air is dispensed and improve a reach of the apparatus.

### BRIEF SUMMARY OF THE INVENTION

An embodiment of the disclosure meets the needs presented above by generally comprising a housing has a top side, a bottom side, a front side, and a back side. The housing has an intake vent and an outlet hole each extending therethrough to an interior space positioned in the housing. A blower is mounted in the housing and is configured for urging air to flow into the housing through the intake vent and out of the housing through the outlet hole. A heater is mounted in the housing and is configured for heating the air flowing through the housing. A duct is coupled to and extends forwardly from the housing. The duct is in fluid communication with the outlet hole of the housing, and a discharge end of the duct is positioned distally from the housing. The duct comprises a plurality of sections which are telescopically interconnected such that the duct is extendable away from the housing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an ice and snow removal apparatus according to an embodiment of the disclosure.

FIG. 2 is a first side view of an embodiment of the disclosure.

FIG. 3 is a back view of an embodiment of the disclosure.

FIG. 4 is a second side view of an embodiment of the disclosure.

FIG. 5 is an in-use view of an embodiment of the disclosure.

FIG. 6 is a block diagram of an embodiment of the disclosure.

### DETAILED DESCRIPTION OF THE INVENTION

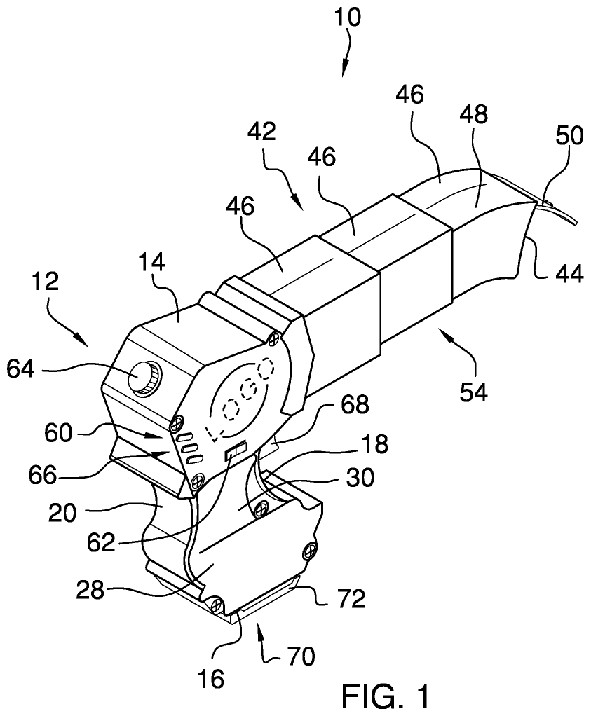

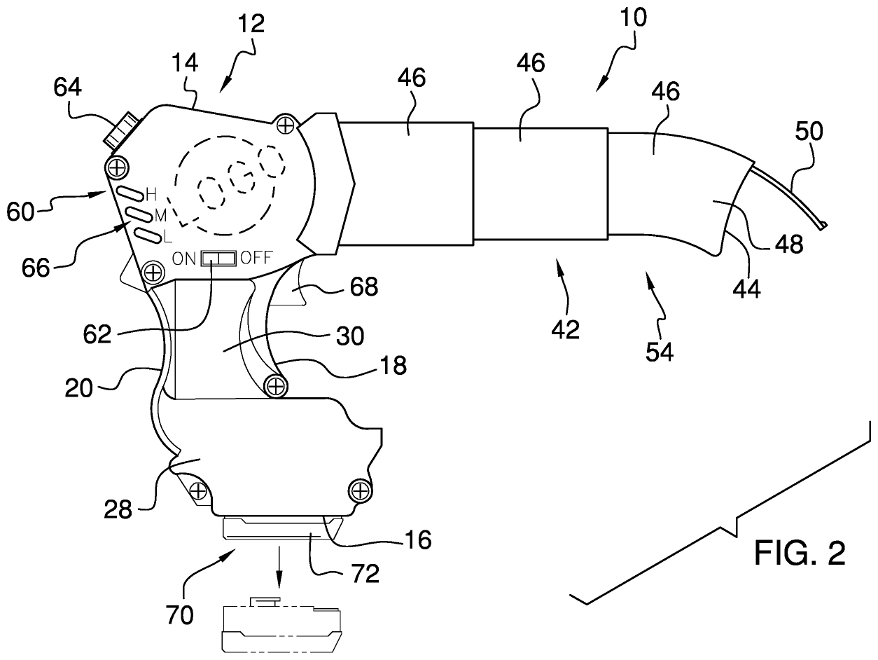

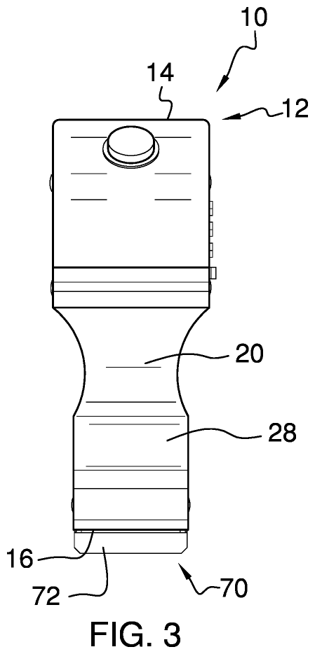

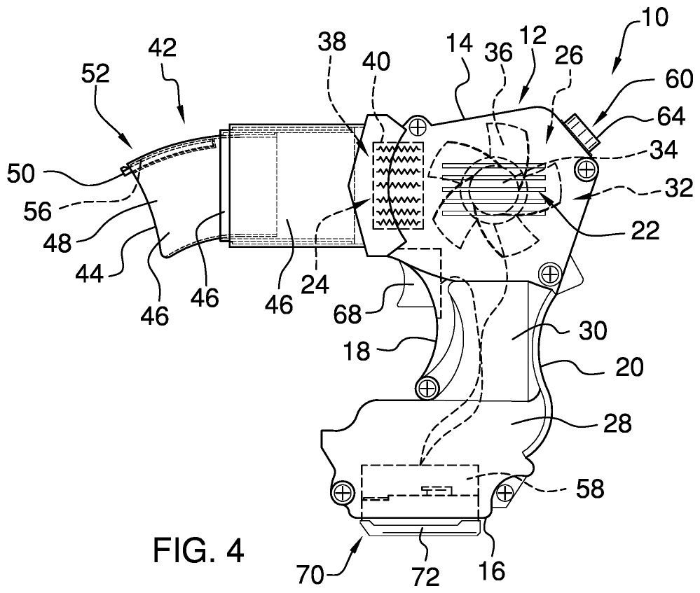

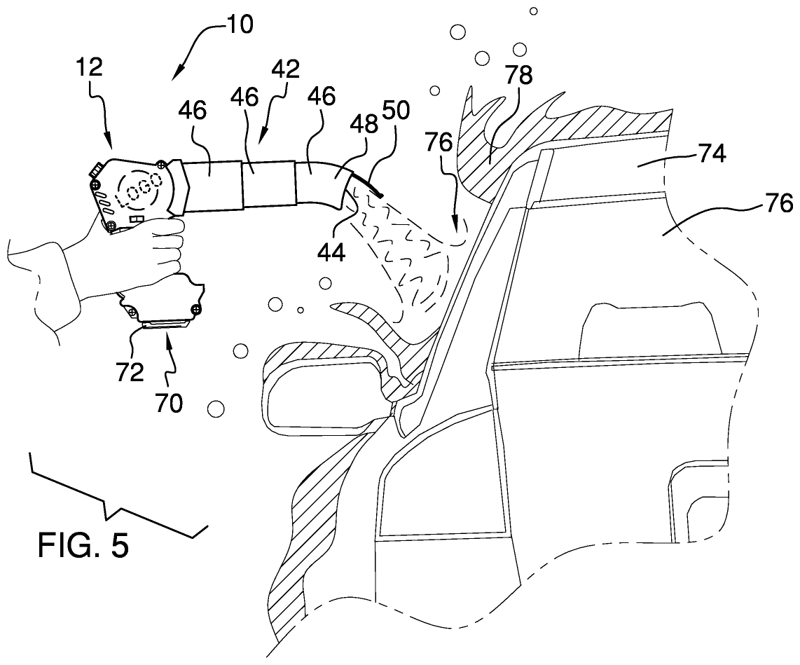

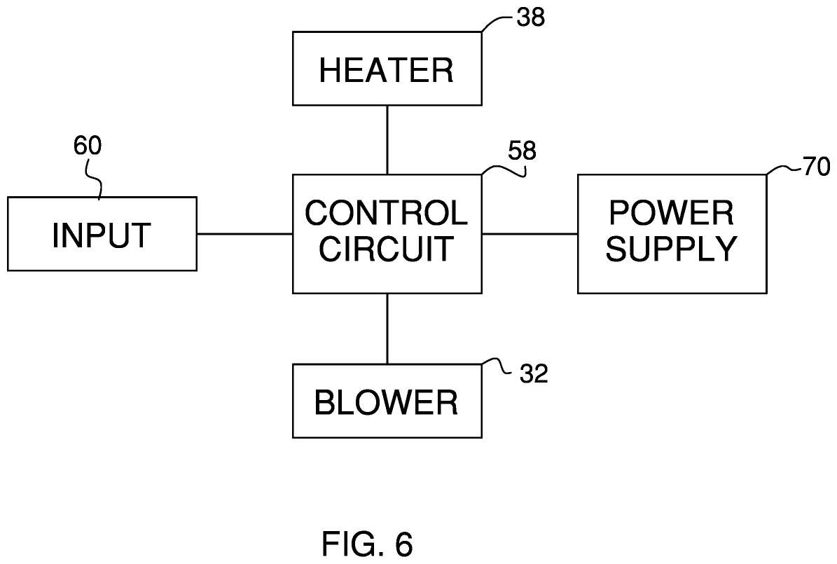

With reference now to the drawings, and in particular to FIGS. 1 through 6 thereof, a new ice and snow removal apparatus embodying the principles and concepts of an embodiment of the disclosure and generally designated by the reference numeral 10 will be described.

As best illustrated in FIGS. 1 through 6, the ice and snow removal apparatus 10 generally comprises a housing 12 having a top side 14, a bottom side 16, a front side 18, and a back side 20. The housing 12 has an intake vent 22 and an outlet hole 24 each extending therethrough to an interior space 26 positioned in the housing 12. A portion of an exterior 28 of the housing 12 defines a pistol grip handle 30. The outlet hole 24 is positioned on the front side 18 of the housing 12 adjacent to the top side 14 of the housing 12. A blower 32 is mounted in the housing 12 and is configured for urging air to flow into the housing 12 through the intake vent 22 and out of the housing 12 through the outlet hole 24. The blower 32 comprises a motor 34 and a fan 36, wherein the fan 36 is operably coupled to the motor 34. A heater 38 is mounted in the housing 12 and is configured for heating the air flowing through the housing 12. The heater 38 comprises a resistance heater 40 but may comprise any conventional heating means.

A duct 42 is coupled to and extends forwardly from the housing 12. The duct 42 is in fluid communication with the outlet hole 24 of the housing 12, and a discharge end 44 of the duct 42 is positioned distally from the housing 12. The duct 42 comprises a plurality of sections 46 which are telescopically interconnected such that the duct 42 is extendable away from the housing 12. A distal section 48 of the plurality of sections 46 with respect to the housing 12 is angled downwardly away from the housing 12 such that the duct 42 is configured for directing the air flowing through the housing 12 forwardly and downwardly relative to the housing 12.

A guide panel 50 is coupled to the distal section 48 of the duct 42 and is movable between a retracted position 52 and an extended position 54 with respect to the distal section 48. The extended position 54 is defined by the guide panel 50 extending forwardly and downwardly relative to the distal section 48 such that the guide panel 50 is configured for directing the air flowing through the housing 12 forwardly and downwardly relative to the distal section 48 when the guide panel 50 is positioned in the extended position 54. An inner top surface 56 of the distal section 48 is concavely arcuate, and the guide panel 50 is curved. The retracted position 52 is defined by the guide panel 50 being positioned adjacent to and extending along the inner top surface 56 of the distal section 48.

A control circuit 58 is mounted in the housing 12 and is electrically coupled to the blower 32 and the heater 38. An input 60 is in communication with the control circuit 58 and is actuatable to cause the control circuit 58 to activate the blower 32 and the heater 38. The input 60 comprises a power control 62, a speed control 64, a temperature control 66, and a trigger 68. The power control 62 is actuatable to turn the control circuit 58 alternately on and off. The speed control 64 is actuatable to select a speed at which the blower 32 moves to cause the air to flow through the housing 12. The temperature control 66 is actuatable to select a heat rate at which the heater 38 heats the air flowing through the housing 12. The trigger 68 is actuatable to cause the control circuit 58 to activate the blower 32 at a selected speed and the heater 38 at a selected heat rate. A power supply 70 is mounted to the housing 12 and is electrically coupled to the control circuit 58. The power supply 70 is removable from the housing 12 and comprises a battery 72. The battery 72 is attached via a conventional means such as a latch, snap fit, threaded fastener, or the like. The battery 72 may be rechargeable.

In use, the duct 42 is positioned to extend from the housing 12 at a desired length, and the guide panel 50 is positioned as desired in one of or between the retracted position 52 and the extended position 54. The discharge end 44 of the duct 42 is positioned near a portion of ice or snow 78. The power control 62 is actuated to turn the control circuit 58 on, the selected speed and the selected heat rate are chosen using the speed control 64 and the temperature control 66. The trigger 68 is actuated to cause the control circuit 58 to activate the blower 32 at the selected speed and the heater 38 at the selected heat rate to melt and blow away the portion of ice or snow 78. The ice and snow removal apparatus 10 may be used, for example, to remove ice and snow 78 from a plurality of windows 76 of an automobile 74.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An ice and snow removal apparatus comprising:
a housing having a top side, a bottom side, a front side, and a back side, the housing having an intake vent and an outlet hole each extending therethrough to an interior space positioned in the housing;
a blower being mounted in the housing and being configured for urging air to flow into the housing through the intake vent and out of the housing through the outlet hole;
a heater being mounted in the housing and being configured for heating the air flowing through the housing; and
a duct being coupled to and extending forwardly from the housing, the duct being in fluid communication with the outlet hole of the housing, a discharge end of the duct being positioned distally from the housing, the duct comprising a plurality of sections which are telescopically interconnected such that the duct is extendable away from the housing.

2. The apparatus of claim 1, wherein a portion of an exterior of the housing defines a pistol grip handle, the outlet hole being positioned on the front side of the housing adjacent to the top side of the housing.

3. The apparatus of claim 1, wherein the blower comprises a motor and a fan, the fan being operably coupled to the motor.

4. The apparatus of claim 1, wherein the heater comprises a resistance heater.

5. The apparatus of claim 1, wherein a distal section of the plurality of sections with respect to the housing is angled downwardly away from the housing such that the duct is configured for directing the air flowing through the housing forwardly and downwardly relative to the housing.

6. The apparatus of claim 5, further comprising a guide panel being coupled to the distal section of the duct, the guide panel being movable between a retracted position and an extended position with respect to the distal section, the extended position being defined by the guide panel extending forwardly and downwardly relative to the distal section such that the guide panel is configured for directing the air flowing through the housing forwardly and downwardly relative to the distal section when the guide panel is positioned in the extended position.

7. The apparatus of claim 6, wherein an inner top surface of the distal section is concavely arcuate and the guide panel is curved, the retracted position being defined by the guide panel being adjacent to and extending along the inner top surface of the distal section.

8. The apparatus of claim 1, further comprising:
a control circuit being mounted in the housing and being electrically coupled to the blower and the heater; and
an input being in communication with the control circuit, the input being actuatable to cause the control circuit to activate the blower and the heater.

9. The apparatus of claim 8, wherein the input comprises:
a power control being actuatable to turn the control circuit alternately on and off;
a speed control being actuatable to select a speed at which the blower moves to cause the air to flow through the housing;
a temperature control being actuatable to select a heat rate at which the heater heats the air flowing through the housing; and
a trigger being actuatable to cause the control circuit to activate the blower at a selected speed and the heater at a selected heat rate.

10. The apparatus of claim 8, further comprising a power supply being mounted to the housing and being electrically coupled to the control circuit.

11. The apparatus of claim 10, wherein the power supply is removable from the housing.

12. The apparatus of claim 10, wherein the power supply comprises a battery.

13. An ice and snow removal apparatus comprising:
a housing having a top side, a bottom side, a front side, and a back side, the housing having an intake vent and an outlet hole each extending therethrough to an interior space positioned in the housing, a portion of an exterior of the housing defining a pistol grip handle, the outlet hole being positioned on the front side of the housing adjacent to the top side of the housing;
a blower being mounted in the housing and being configured for urging air to flow into the housing through the intake vent and out of the housing through the outlet hole, the blower comprising a motor and a fan, the fan being operably coupled to the motor;
a heater being mounted in the housing and being configured for heating the air flowing through the housing, the heater comprising a resistance heater;
a duct being coupled to and extending forwardly from the housing, the duct being in fluid communication with the outlet hole of the housing, a discharge end of the duct being positioned distally from the housing, the duct comprising a plurality of sections which are telescopically interconnected such that the duct is extendable away from the housing, a distal section of the plurality of sections with respect to the housing being angled downwardly away from the housing such that the duct is configured for directing the air flowing through the housing forwardly and downwardly relative to the housing;
a guide panel being coupled to the distal section of the duct, the guide panel being movable between a retracted position and an extended position with respect to the distal section, the extended position being defined by the guide panel extending forwardly and downwardly relative to the distal section such that the guide panel is configured for directing the air flowing through the housing forwardly and downwardly relative to the distal section when the guide panel is positioned in the extended position, an inner top surface of the distal section being concavely arcuate and the guide panel being curved, the retracted position being defined by the guide panel being adjacent to and extending along the inner top surface of the distal section;
a control circuit being mounted in the housing and being electrically coupled to the blower and the heater;
an input being in communication with the control circuit, the input being actuatable to cause the control circuit to activate the blower and the heater, the input comprising:
a power control being actuatable to turn the control circuit alternately on and off;
a speed control being actuatable to select a speed at which the blower moves to cause the air to flow through the housing;
a temperature control being actuatable to select a heat rate at which the heater heats the air flowing through the housing; and
a trigger being actuatable to cause the control circuit to activate the blower at a selected speed and the heater at a selected heat rate; and
a power supply being mounted to the housing and being electrically coupled to the control circuit, the power supply being removable from the housing, the power supply comprising a battery.
